(19) United States
(12) Patent Application Publication
(10) Pub. No.: US 2019/0255946 A1
(43) Pub. Date: Aug. 22, 2019

(54) PROJECTION DEVICE AND VEHICLE DISPLAY DEVICE

(71) Applicant: Yazaki Corporation, Tokyo (JP)

(72) Inventor: Nobuyuki TAKAHASHI, Shizuoka (JP)

(73) Assignee: Yazaki Corporation, Tokyo (JP)

(21) Appl. No.: 16/280,108

(22) Filed: Feb. 20, 2019

(30) Foreign Application Priority Data
Feb. 21, 2018 (JP) 2018-028639

(51) Int. Cl. B60K 35/00; G02B 27/01; G02B 17/06; G02B 27/28; B60K 37/04

(52) U.S. Cl. CPC B60K 35/00; G02B 27/0101; G02B 17/0668; G02B 2027/0169; G02B 27/286; B60K 37/04; G02B 2027/0161; G02B 27/0149

(57) ABSTRACT

A projection device includes a display that emits a first linearly polarized light that oscillates in a reference oscillation direction, a transparent cover that blocks an opening of a housing, and that reflects the first linearly polarized light that is emitted by the display, and a half-wavelength plate that converts the first linearly polarized light entering from the transparent cover into a second linearly polarized light that oscillates in a direction orthogonal to the reference oscillation direction, and transmits the second linearly polarized light. The transparent cover includes a convex curved surface protruding toward an interior of the housing, and is structured to reflect the first linearly polarized light that is emitted by the display, toward the half-wavelength plate, and to transmit the second linearly polarized light from a reflection mirror toward a combiner.

### CROSS-REFERENCE TO RELATED APPLICATION(S)

The present application claims priority to and incorporates by reference the entire contents of Japanese Patent Application No. 2018-028639 filed in Japan on Feb. 21, 2018.

### BACKGROUND OF THE INVENTION

### 1. Field of the Invention

The present invention relates to a projection device and a vehicle display device.

### 2. Description of the Related Art

Conventionally, a vehicle display device such as a head-up display device (HUD: Head Up Display) is installed in some vehicles, such as cars. A head-up display device projects a display image, which is displayed by a display, on a windshield or a combiner through a reflection mirror or the like so that the display image is seen by a driver as a virtual image (for example, see Japanese Patent Application Laid-open No. 2016-587). With a vehicle display device described in Japanese Patent Application Laid-open No. 2016-587 A, a transparent cover that transmits the display image is provided at an opening portion of an instrument panel, and dust and the like are prevented from entering inside the device by the transparent cover.

These days, with a vehicle display device, a size of a display image is being increased by using an aspheric concave mirror as a reflection mirror. However, there is a limit to increasing a magnification ratio by increasing a curvature of the reflection mirror. A plurality of reflection mirrors may be arranged as a solution, but this possibly increases a size of a housing that houses the plurality of reflection mirrors.

### SUMMARY OF THE INVENTION

The present invention has its object to provide a projection device and a vehicle display device which are capable of increasing a size of a display screen, and of reducing a size of a housing.

In order to achieve the above mentioned object, a projection device according to one aspect of the present invention includes a display that emits, as a display light, a display image that is projected on a projected member provided in a vehicle; a cover member that blocks an opening formed at a housing, and that reflects the display light that is emitted by the display; an aspheric mirror that is located at a position of folding an optical path of the display light between the display and the projected member, and that reflects the display light entering from the cover member; and a half-wavelength plate that is disposed on the optical path of the display light, at a position facing the cover member, and that transmits the display light entering from the cover member, toward the aspheric mirror, wherein the display emits a first linearly polarized light that oscillates in a reference oscillation direction, the half-wavelength plate converts the first linearly polarized light entering from the cover member into a second linearly polarized light that oscillates in a direction orthogonal to the reference oscillation direction, and transmits the second linearly polarized light, and the cover member includes a convex curved surface protruding toward an interior of the housing, and is structured to reflect the first linearly polarized light that is emitted by the display, toward the half-wavelength plate, and to transmit the second linearly polarized light from the aspheric mirror toward the projected member.

In order to achieve the above mentioned object, a projection device according to another aspect of the present invention includes a display that emits, as a display light, a display image that is projected on a projected member provided in a vehicle; a cover member that blocks an opening formed at a housing, and that reflects the display light that is emitted by the display; an aspheric mirror that is located at a position of folding an optical path of the display light between the display and the projected member, and that reflects the display light entering from the cover member; and a half-wavelength plate that is disposed on the optical path of the display light, at a position facing the cover member, and that transmits the display light entering from the aspheric mirror, toward the cover member, wherein the display emits a first linearly polarized light that oscillates in a reference oscillation direction, the half-wavelength plate converts the first linearly polarized light entering from the aspheric mirror into a second linearly polarized light that oscillates in a direction orthogonal to the reference oscillation direction, and transmits the second linearly polarized light, and the cover member includes a convex curved surface protruding toward an interior of the housing, and is structured to reflect the first linearly polarized light that is emitted by the display, toward the aspheric mirror, and to transmit the second linearly polarized light that is transmitted through the half-wavelength plate, toward the projected member.

In order to achieve the above mentioned object, a vehicle display device according to still another aspect of the present invention includes a display that emits, as a display light, a display image that is projected on a projected member; a polarizing member that forms a part of an interior member that is provided in a vehicle interior of a vehicle, on a front side, in a front-back direction, of the vehicle, while extending in a width direction intersecting the front-back direction of the vehicle, the polarizing member being configured to reflect at least a part of the display light that is emitted by the display; a reflection member that is located at a position of folding an optical path of the display light between the polarizing member and the projected member, and that reflects the display light; and a wavelength plate that is located on the optical path of the display light, and that transmits the display light, wherein the display emits a first linearly polarized light that oscillates in a reference oscillation direction, the wavelength plate converts the first linearly polarized light into a second linearly polarized light that oscillates in a direction orthogonal to the reference oscillation direction, and the polarizing member is structured to reflect the first linearly polarized light, and to transmit the second linearly polarized light toward the projected member.

According to still another aspect of the present invention, in the vehicle display device, it is possible to configure that the wavelength plate is disposed between the polarizing member and the reflection member, and converts the first linearly polarized light that is reflected by one of the polarizing member or the reflection member into the second linearly polarized light.

According to still another aspect of the present invention, in the vehicle display device, it is possible to configure that the projected member has a light-transmitting property, and is disposed facing the vehicle interior, at a position visible to a driver in the vehicle interior.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic configuration diagram of a projection device according to a first embodiment;

FIG. 2 is a schematic diagram illustrating a change in display light of the projection device according to the first embodiment;

FIG. 3 is a schematic configuration diagram of a vehicle display device according to a second embodiment;

FIG. 4 is a schematic configuration diagram of a vehicle display device according to a third embodiment; and

FIG. 5 is a schematic configuration diagram of a projection device according to a fourth embodiment.

### DETAILED DESCRIPTION OF THE PREFERRED EMBODIMENTS

Hereinafter, embodiments of a projection device and a vehicle display device according to the present invention will be described in detail with reference to the drawings. The invention is not limited to the embodiments. The structural elements in the embodiments described below include those that can be easily assumed by persons skilled in the art, or those that are substantially the same. Various omissions, substitutions, and modifications may be made with respect to the structural elements in the embodiments described below within the scope of the invention.

### First Embodiment

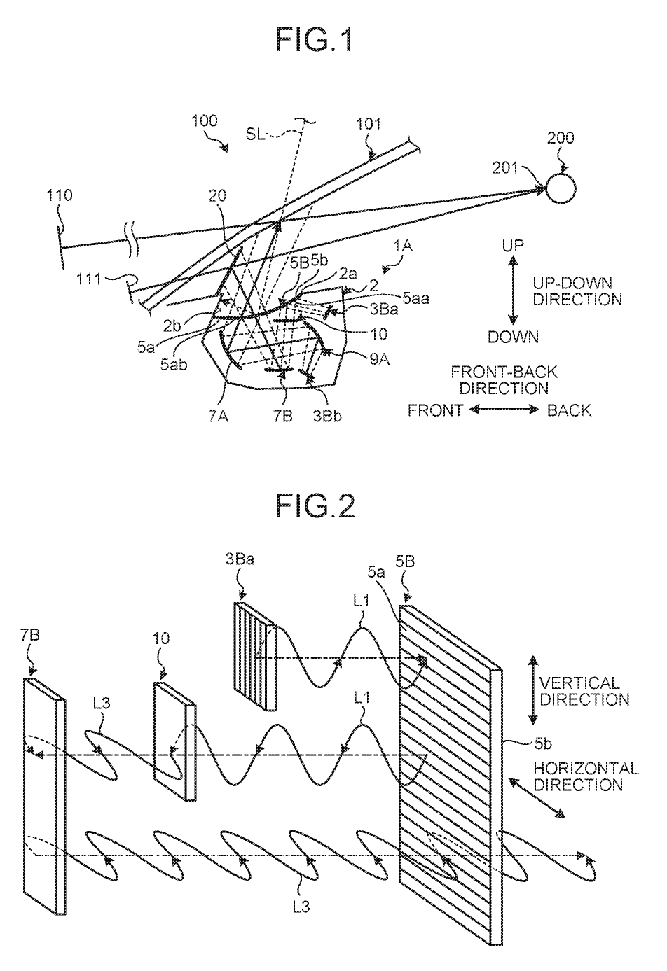

A projection device 1A according to a first embodiment of the present invention will be described with reference to FIGS. 1 and 2. FIG. 1 is a schematic configuration diagram of the projection device according to the first embodiment. FIG. 2 is a schematic diagram illustrating a change in display light of the projection device according to the first embodiment. FIG. 2 illustrates an optical path of the display light from a display 3Ba to a combiner 20, which are illustrated in FIG. 1.

For example, the projection device 1A is a head-up display device which is disposed inside an instrument panel (not illustrated) of a vehicle 100, such as a car, and which projects a display image on at least one of a windshield 101 and the combiner 20. The projection device 1A projects a display image on the windshield 101, and displays a virtual image 110 before an eye point 201 of a driver 200. The windshield 101 is a projected member, and has a semi-transparent property that reflects a part of entering light and transmits another part. Specifically, the windshield 101 reflects, as display light, a display image that is projected by the projection device 1A to the eye point 201 of the driver 200, while transmitting a foreground of the vehicle 100. The windshield 101 is disposed above the instrument panel of the vehicle 100. The eye point 201 is assumed in advance to be a viewpoint position of the driver 200 of the vehicle 100. The driver 200 recognizes the display image reflected by the windshield 101, as the virtual image 110. The virtual image 110 is recognized by the driver 200 to be in front of the windshield 101.

The projection device 1A projects a display image on the combiner 20, and displays a virtual image 111 before the eye point 201 of the driver 200. The combiner 20 is a projected member, and is a concave mirror which is a semitransparent mirror formed into a rectangular shape, for example. The combiner 20 has a semi-transparent property that reflects a part of entering light and transmits another part. The combiner 20 is installed in an upright manner at an edge portion at a front, in a front-back direction, of a housing 2, in a manner extending on an upper side, in an up-down direction, of a light-shielding wall 2b.

In the present specification, the “front-back direction” refers to a front-back direction of the vehicle 100 unless particularly specified otherwise. The “up-down direction” refers to an up-down direction of the vehicle 100, and a “width direction” refers to a vehicle width direction of the vehicle 100 unless particularly specified otherwise.

The projection device 1A includes a housing 2, displays 3Ba, 3Bb, a transparent cover 5B, a half-wavelength plate 10, and reflection mirrors 7A, 9A, 7B. The projection device 1A of the present embodiment includes an optical path of display light from the display 3Ba to the combiner 20, and an optical path of display light from the display 3Bb to the windshield 101.

The housing 2 is formed to have a hollow box-shaped interior, and houses a plurality of displays 3Ba, 3Bb, a plurality of reflection mirrors 7A, 9A, and the like in an interior space. An opening 2a where display light emitted toward the windshield 101 and the combiner 20 passes through is formed to the housing 2. The opening 2a is formed on an upper side, in the up-down direction, of the housing 2 while extending in the front-back direction and the width direction of the housing 2, and is positioned at a position facing the windshield 101. The housing 2 includes the light-shielding wall 2b, which is installed in an upright manner at an edge portion at a front, in the front-back direction, of the opening 2a. The light-shielding wall 2b is formed in a manner protruding upward in the up-down direction, and extending in the width direction. Specifically, the light-shielding wall 2b is formed in a manner protruding upward from an edge portion at a front, in the front-back direction, of the transparent cover 5B, and extending in the width direction of the transparent cover 5B. The light-shielding wall 2b shields outside light SL at the front, in the front-back direction, of the transparent cover 5B, and prevents reflection of the outside light SL by the transparent cover 5B. The outside light SL is light such as sunlight or street light entering the vehicle from outside the vehicle 100, for example.

The display 3Ba emits, as display light, a display image to be projected on the combiner 20. For example, the display 3Ba includes a liquid crystal panel (not illustrated), and a backlight unit (not illustrated). The liquid crystal panel is formed of a light-transmitting or light semi-transmitting thin film transistor (TFT) liquid crystal display, for example. A display surface on a front surface side of the liquid crystal panel emits light when the liquid crystal panel is irradiated from a back surface side. The backlight unit is for irradiating the liquid crystal panel from the back surface side. For example, the backlight unit is driven by power supplied from a battery (not illustrated) in the vehicle 100. As illustrated in FIG. 2, the display 3Ba of the present embodiment emits, as display light L1, linearly polarized light that oscillates in a reference oscillation direction.

The display 3Bb is for emitting, as display light, a display image to be projected on the windshield 101. Like the display 3Ba, the display 3Bb includes a liquid crystal panel (not illustrated), and a backlight unit (not illustrated). The display 3Bb of the present embodiment emits linearly polarized light that oscillates in a direction orthogonal to the reference oscillation direction. That is, the display 3Bb has a polarization axis along a horizontal direction, and emits display light L3 that is parallel to the polarization axis. For example, the display 3Bb is disposed in such a way that a polarization axis (transmission axis) of a polarizing plate on a light-emitting side, of polarizing plates forming the liquid crystal panel, is along the horizontal direction.

The transparent cover 5B is a cover member that blocks the opening 2a provided at the housing 2, and that reflects at least a part of display light. The transparent cover 5B prevents dust and the like from entering the housing 2 from outside, by blocking the opening 2a. The transparent cover 5B is configured of a light-transmitting member for transmitting display light emitted by the display 3Ba, 3Bb, such as glass or synthetic resin such as acrylic resin or polycarbonate, and a polarizing member combined with the aforementioned member. The polarizing member includes a polarizing film, for example. The polarizing film is affixed to a surface, of the transparent cover 5B, facing an inside of the housing, and is combined with the light-transmitting member. Typically, the polarizing member has a polarization axis, and transmits light that oscillates in parallel to the polarization axis, and reflects light that oscillates in a direction orthogonal to the polarization axis. That is, as illustrated in FIG. 2, the transparent cover 5B has a polarization axis along the horizontal direction orthogonal to a vertical direction, and transmits the display light L3, which oscillates in a direction parallel to the polarization axis (i.e., a direction orthogonal to the reference oscillation direction), and reflects the display light L1, which oscillates in a direction orthogonal to the polarization axis (i.e., the reference oscillation direction). The transparent cover 5B of the present embodiment is configured to reflect display light which is emitted by the display 3Ba, toward the half-wavelength plate 10, while transmitting display light which is reflected by the reflection mirror 7B, toward the combiner 20. The transparent cover 5B may also transmit display light which is reflected by the reflection mirror 7A, toward the windshield 101.

The transparent cover 5B includes a convex curved surface 5a protruding toward the inside of the housing 2, and a concave curved surface 5b provided on an opposite surface from the convex curved surface 5a and recessed from an outside of the housing 2. For example, the convex curved surface 5a and the concave curved surface 5b are aspheric surfaces (such as a freely curved surface). The convex curved surface 5a of the present embodiment is shaped to correct field curvature aberration caused by an influence of at least one of a curved surface included in an optical system such as the reflection mirror 7A and a surface shape of the windshield 101 of the vehicle 100. The concave curved surface 5b of the present embodiment includes a function of a reflection mirror that reflects the outside light SL entering the transparent cover 5B from outside the vehicle 100. That is, the concave curved surface 5b reflects the outside light SL entering the transparent cover 5B, in a direction different from an eye point direction toward the eye point 201 of the driver 200. For example, the concave curved surface 5b reflects the entering outside light SL toward the light-shielding wall 2b. A thickness between the convex curved surface 5a and the concave curved surface 5b, or in other words, a thickness of the transparent cover 5B, is preferably thick from the viewpoint of strength; however, if the thickness is increased, an influence of rear surface reflection of the convex curved surface 5a and the concave curved surface 5b on a display image is possibly increased, and the thickness preferably takes such an influence into account. The transparent cover 5B includes, on a side of the convex curved surface 5a, a reflection surface 5aa and a transmission surface 5ab. The reflection surface 5aa is a surface that reflects, toward the half-wavelength plate 10, linearly polarized light (first linearly polarized light) in the vertical direction emitted by the display 3Ba. The transmission surface 5ab is a surface that transmits, toward the windshield 101, linearly polarized light (second linearly polarized light) in the horizontal direction that is transmitted from the transparent cover 5B through the half-wavelength plate 10 and that is polarized. The reflection surface 5aa and the transmission surface 5ab of the present embodiment are provided at different positions on the side of the convex curved surface 5a of the transparent cover 5B. An installation position may thus be easily secured for the half-wavelength plate 10. Additionally, the reflection surface 5aa and the transmission surface 5ab may be provided at a same position on the side of the convex curved surface 5a of the transparent cover 5B.

The half-wavelength plate 10 is disposed on the optical path of display light, at a position facing the transparent cover 5B, and the half-wavelength plate 10 transmits display light entering from the transparent cover 5B toward the reflection mirror 7B. The half-wavelength plate 10 is a type of so-called wavelength plate, and is formed from a birefringent material, for example. The half-wavelength plate 10 causes a phase difference (optical path difference) to occur between two beams of linearly polarized light, the oscillation directions of which are orthogonal to each other. The half-wavelength plate 10 of the present embodiment takes an oscillation direction of display light that is emitted by the display 3Ba as the reference oscillation direction, and converts the display light L1 entering from the transparent cover 5B into the display light L3 that oscillates in a direction inclined by 90 degrees with respect to the reference oscillation direction. That is, as illustrated in FIG. 2, the half-wavelength plate 10 converts linearly polarized light (display light L1) that is reflected by the convex curved surface 5a of the transparent cover 5B into linearly polarized light (display light L3) that oscillates in a direction orthogonal to the reference oscillation direction. In this manner, the half-wavelength plate 10 changes the polarization axis of linearly polarized light that is transmitted from the vertical direction to the horizontal direction.

The reflection mirrors 7A, 9A are for reflecting display light, and are each at a position of folding the optical path of display light between the display 3Bb and the windshield 101. The reflection mirrors 7A, 9A are optical systems that change, inside the housing 2, the optical path of display light that is emitted by the display 3Bb. The reflection mirrors 7A, 9A of the present embodiment are magnifying mirrors, and are each formed of an aspheric mirror having a concave reflection surface (such as a freely curved surface mirror), for example. The reflection mirror 9A of the present embodiment totally reflects display light that is emitted by the display 3Bb, toward the reflection mirror 7A. The reflection mirror 7A of the present embodiment totally reflects the display light that is reflected by the reflection mirror 9A, toward the windshield 101. The reflection mirror 7A is fixed to the housing 2, but may alternatively be supported by an adjustment mechanism for finely adjusting a reflection angle of display light that is radiated on the windshield 101.

The reflection mirror 7B is for reflecting display light, and is located at a position of folding the optical path of display light between the display 3Ba and the combiner 20. The reflection mirror 7B is an optical system that changes, inside the housing 2, the optical path of display light that is emitted by the display 3Ba. The reflection mirror 7B of the present embodiment is a magnifying mirror, and is formed of a concave mirror, a reflection surface of which is a concave freely curved surface, for example. That is, the reflection mirror 7B magnifies and reflects a display image in such a way that a display image that is formed by display light after reflection by the reflection mirror 7B is larger than a display image that is formed by display light before reflection by the reflection mirror 7B. The reflection mirror 7B of the present embodiment totally reflects display light that is reflected by the transparent cover 5B, toward the combiner 20. The reflection mirror 7B is fixed and supported by the housing 2, but may alternatively be supported by an adjustment mechanism for finely adjusting a reflection angle of display light that is radiated on the combiner 20.

Next, a projection operation of the projection device 1A will be described with reference to FIG. 1. First, display light that is emitted by the display 3Ba is propagated toward the transparent cover 5B. The transparent cover 5B reflects the display light entering from the display 3Ba, toward the half-wavelength plate 10 by the convex curved surface 5a. The half-wavelength plate 10 transmits the display light entering from the transparent cover 5B, toward the reflection mirror 7B. The display light entering the reflection mirror 7B is totally reflected by the concave reflection surface, and is propagated again toward the transparent cover 5B. The transparent cover 5B transmits the display light entering from the reflection mirror 7B, from the convex curved surface 5a to the combiner 20 through the concave curved surface 5b. A display image is thereby projected on the combiner 20, and the virtual image 111 is displayed before the eye point 201 of the driver 200.

For its part, display light that is emitted by the display 3Bb is propagated toward the reflection mirror 9A. The display light entering the reflection mirror 9A is totally reflected by the concave reflection surface, and is propagated toward the reflection mirror 7A. The reflection mirror 7A totally reflects the display light entering from the reflection mirror 9A, toward the transparent cover 5B. The transparent cover 5B transmits the display light entering from the reflection mirror 7A, from the convex curved surface 5a to the windshield 101 through the concave curved surface 5b. A display image is thereby projected on the windshield 101, and the virtual image 110 is displayed before the eye point 201 of the driver 200.

The projection device 1A described above includes the transparent cover 5B that blocks the opening 2a of the housing 2, and the transparent cover 5B reflects display light that is emitted by the display 3Ba, toward the half-wavelength plate 10, and transmits display light that is reflected by the reflection mirror 7B, toward the combiner 20. By reflecting the display light by the transparent cover 5B in such a way, an optical path length of display light may be increased, and a display image that is the display light may be magnified due to the increased optical path length, and a size of a display screen may be increased. Because the optical path length of display light may be increased without newly adding optical system parts, a size of the housing 2 may be reduced.

In the embodiment described above, the display 3Ba emits linearly polarized light that oscillates in the vertical direction with respect to linearly polarized light in the horizontal direction that is transmitted through the transparent cover 5B, but such a case is not restrictive. For example, the display 3Ba may emit linearly polarized light that oscillates in the horizontal direction, and the transparent cover 5B may transmit linearly polarized light that oscillates in the vertical direction.

In the embodiment described above, one reflection mirror 7B is provided on the optical path of display light from the display 3Ba to the combiner 20 in the projection device 1A, but such a case is not restrictive, and a plurality of reflection mirrors may be disposed on the optical path.

In the embodiment described above, the convex curved surface 5a of the transparent cover 5B is shaped to correct field curvature aberration. Accordingly, display distortion of a display image that is formed by display light may be corrected by the display light being reflected by the convex curved surface 5a of the transparent cover 5B, and display quality may be improved.

In the embodiment described above, the reflection mirrors 7A, 7B, 9A each include a function of a magnifying mirror, but such a case is not restrictive, and the reflection mirrors 7A, 7B, 9A may each include a function of a correction mirror described above. The reflection mirror 7A, 7B, 9A that functions as the magnifying mirror and the correction mirror is formed as a freely curved surface mirror which is asymmetric with respect to an optical axis, unlike a spherical surface or a paraboloidal surface.

### Second Embodiment

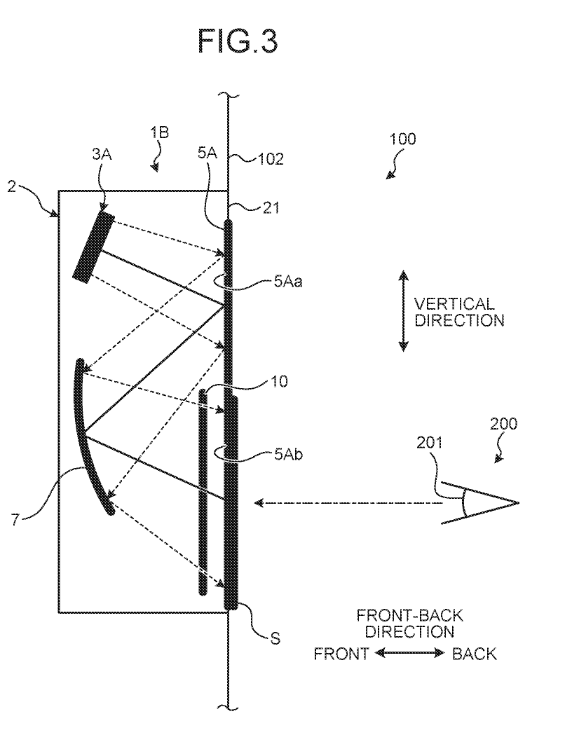

Next, a vehicle display device 1B according to a second embodiment of the present invention will be described with reference to FIG. 3. FIG. 3 is a schematic configuration diagram of the vehicle display device according to the second embodiment. In the following, structural elements the same as those in the embodiment described above will be denoted by same reference signs, and a redundant description of same configurations, operations, and effects will be omitted as much as possible.

For example, the vehicle display device 1B is a projection device that is disposed inside an instrument panel 102 of a vehicle 100, such as a car, and that projects a display image on a screen S. The instrument panel 102 is an interior member that is provided in a vehicle interior, of the vehicle 100, where a driver's seat and the like are provided, on a front side of the vehicle 100 in the front-back direction, while extending in the width direction intersecting the front-back direction of the vehicle 100. The vehicle display device 1B projects a display image on the screen S, and displays the display image before an eye point 201 of a driver 200. The screen S is a projected member, and is a screen that is provided in the instrument panel 102. The screen S is a member, in the instrument panel 102, on which display light that forms a display image is projected by the vehicle display device 1B, and is disposed at an arbitrary position. The screen S forms, in the instrument panel 102, a transmitting screen that transmits light from the side of the vehicle display device 1B to the side of the eye point 201 in the vehicle interior, and that scatters the light that is transmitted. Additionally, with respect to the eye point 201, the driver 200 of the vehicle 100 is assumed, but another passenger on the vehicle 100 may alternatively be assumed. The screen S is sometimes referred to as a rear projection screen. That is, when display light for forming a display image enters from the vehicle display device 1B, the screen S transmits and scatters the display light to thereby enable the driver 200 or the like to see the display image. To desirably transmit and scatter, at the instrument panel 102, display light for forming a display image projected by the vehicle display device 1B, the screen S is formed of a light-transmitting semitransparent member such as vinyl resin, acrylic resin, or glass. The screen S is provided to be entirely in contact with the vehicle display device 1B.

The vehicle display device 1B includes a housing 2, a display 3A, a polarizing member 5A, a reflection mirror 7, and a half-wavelength plate 10. The vehicle display device 1B of the present embodiment has an optical path of display light from the display 3A to the screen S.

The housing 2 is formed to have a hollow box-shaped interior, and houses the display 3A, the reflection mirror 7, and the half-wavelength plate 10 in an interior space. The housing 2 includes a wall surface 21 that is formed on a rear side in the front-back direction, and that forms a part of the instrument panel 102. The wall surface 21 is formed on a vehicle interior side of the instrument panel 102, on a same surface as the instrument panel 102.

The display 3A emits, as display light, a display image to be projected on the screen S. For example, the display 3A includes a liquid crystal panel (not illustrated), and a backlight unit (not illustrated). The liquid crystal panel is formed of a light-transmitting or light semi-transmitting thin film transistor (TFT) liquid crystal display, for example. A display surface on a front surface side of the liquid crystal panel emits light when the liquid crystal panel is irradiated from a back surface side. The backlight unit is for irradiating the liquid crystal panel from the back surface side. For example, the backlight unit is driven by power supplied from a battery (not illustrated) in the vehicle. The display 3A of the present embodiment emits linearly polarized light (first linearly polarized light) that oscillates in a reference oscillation direction. For example, the reference oscillation direction is a vertical direction, and is a direction parallel to a polarization axis of the display 3A. That is, the display 3A has a polarization axis along the vertical direction, and emits display light that is parallel to the polarization axis. For example, the display 3A is disposed in such a way that a polarization axis (transmission axis) of a polarizing plate on a light-emitting side, of polarizing plates forming the liquid crystal panel, is along the vertical direction.

The polarizing member 5A is disposed at a position facing the display 3A, and reflects at least a part of display light that is emitted by the display 3A. The polarizing member 5A of the present embodiment is provided on the wall surface 21, of the housing 2, forming a part of the instrument panel 102. That is, the polarizing member 5A forms a part of the instrument panel 102. The polarizing member 5A is formed, together with the wall surface 21, to be on a same surface as the vehicle interior side of the instrument panel 102, but such a case is not restrictive. The polarizing member 5A is configured by a light-transmitting member for transmitting display light emitted by the display 3A, such as glass or synthetic resin such as acrylic resin or polycarbonate, and a polarizing film combined with the aforementioned member. The polarizing member 5A has a transmission axis along a horizontal direction orthogonal to the vertical direction, and reflects linearly polarized light that oscillates in the vertical direction (reference oscillation direction), and transmits linearly polarized light that oscillates in the horizontal direction parallel to the transmission axis (direction orthogonal to the reference oscillation direction). As illustrated in FIG. 1, the polarizing member 5A of the present embodiment is configured to reflect, toward the reflection mirror 7, linearly polarized light (first linearly polarized light) in the vertical direction that is emitted by the display 3A, and to transmit, toward the screen S, linearly polarized light (second linearly polarized light) in the horizontal direction that is transmitted from the reflection mirror 7 and through the half-wavelength plate 10 and that is polarized. The polarizing member 5A includes a reflection surface 5Aa, and a transmission surface 5Ab. The reflection surface 5Aa is a surface that reflects, toward the reflection mirror 7, the linearly polarized light (first linearly polarized light) in the vertical direction that is emitted by the display 3A. The transmission surface 5Ab is a surface that transmits, to the screen S, the linearly polarized light (second linearly polarized light) in the horizontal direction that is transmitted from the reflection mirror 7 and through the half-wavelength plate 10 and that is polarized. The reflection surface 5Aa and the transmission surface 5Ab of the present embodiment are provided at different positions of the polarizing member 5A. An installation position may thus be easily secured for the half-wavelength plate 10. Additionally, the reflection surface 5Aa and the transmission surface 5Ab may be provided at a same position of the polarizing member 5A.

The reflection mirror 7 is a reflection member, and is for reflecting display light at a position of folding an optical path of the display light between the display 3A and the screen S. The reflection mirror 7 is an optical system that changes the optical path of display light that is emitted by the display 3A. The reflection mirror 7 of the present embodiment includes a function of a magnifying mirror, and a reflection surface of the reflection mirror 7 is formed as an aspheric concave curved surface (or convex curved surface), for example. That is, the reflection mirror 7 magnifies and reflects a display image in such a way that a display image that is formed by display light after reflection by the reflection mirror 7 is larger than a display image that is formed by display light before reflection by the reflection mirror 7. The reflection mirror 7 of the present embodiment totally reflects display light entering from the polarizing member 5A, toward the half-wavelength plate 10. The reflection mirror 7 is fixed and supported by the housing 2, but may alternatively be supported by an adjustment mechanism for finely adjusting a reflection angle of display light that is radiated on the screen S.

The half-wavelength plate 10 is a wavelength plate on the optical path of display light for transmitting the display light. The half-wavelength plate 10 is disposed on the optical path of display light between the reflection mirror 7 and the polarizing member 5A, and transmits the display light entering from the reflection mirror 7 side toward the polarizing member 5A. The half-wavelength plate 10 is a type of so-called wavelength plate, and is formed from a birefringent material, for example. Typically, the half-wavelength plate 10 rotates an oscillation direction of entering linearly polarized light by 90 degrees. That is, the half-wavelength plate 10 transmits the first linearly polarized light entering from the reflection mirror 7, and converts the same into the second linearly polarized light. The half-wavelength plate 10 of the present embodiment takes an oscillation direction of display light that is emitted by the display 3A as the reference oscillation direction, and converts the display light entering from the reflection mirror 7 into display light that oscillates in a direction inclined by 90 degrees with respect to the reference oscillation direction, and transmits the display light. That is, the half-wavelength plate 10 converts linearly polarized light (first linearly polarized light) in the vertical direction that is reflected by the polarizing member 5A into linearly polarized light (second linearly polarized light) in the horizontal direction. Additionally, the half-wavelength plate 10 may be disposed on the optical path of display light between the reflection mirror 7 and the polarizing member 5A, on an upstream side (display 3A side) with respect to the reflection mirror 7, or on a downstream side (half-wavelength plate side) as illustrated in FIG. 3.

Next, a display operation of the vehicle display device 1B will be described with reference to FIG. 1. First, display light that is emitted by the display 3A is propagated toward the polarizing member 5A. The polarizing member 5A reflects the display light entering from the display 3A, toward the reflection mirror 7. The display light entering the reflection mirror 7 is totally reflected by the concave reflection surface, and is propagated toward the half-wavelength plate 10. The half-wavelength plate 10 transmits the display light entering from the reflection mirror 7, toward the polarizing member 5A. The polarizing member 5A transmits the display light entering from the half-wavelength plate 10, toward the screen S. A display image is thereby projected on the screen S, and the display image is displayed before the eye point 201 of the driver 200.

The vehicle display device 1B described above includes the polarizing member 5A that forms a part of the instrument panel 102, and that reflects the first linearly polarized light from the display 3A, where the polarizing member 5A transmits, toward the screen S, the second linearly polarized light that is obtained by transmitting, and converting, the first linearly polarized light through the half-wavelength plate 10. By reflecting the display light by the polarizing member 5A in such a way, an optical path length of display light may be increased, and a display image that is the display light may be magnified due to the increased optical path length, and a size of a display screen may be increased. Because the optical path length of display light may be increased without newly adding optical system parts, size and thickness of the housing 2 may be reduced. Furthermore, by increasing the optical path length of display light, far-sight display of a display image may be facilitated.

### Third Embodiment

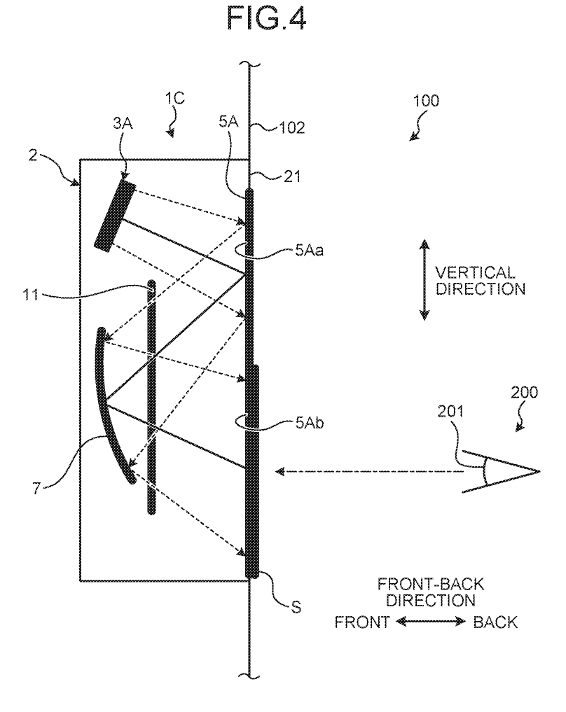

Next, a vehicle display device 1C according to a third embodiment of the present invention will be described with reference to FIG. 4. FIG. 4 is a schematic configuration diagram of the vehicle display device according to the third embodiment. The vehicle display device 1C according to the present embodiment is different from the vehicle display device 1B described above in that a quarter wavelength plate 11 is disposed on an optical path of display light between a reflection mirror 7 and a polarizing member 5A, instead of the half-wavelength plate 10. The vehicle display device 1C includes a housing 2, a display 3A, the polarizing member 5A, the reflection mirror 7, and the quarter wavelength plate 11.

The quarter wavelength plate 11 is disposed on the optical path of display light, at a position facing the reflection mirror 7, and the quarter wavelength plate 11 transmits display light entering from the polarizing member 5A, and also transmits display light entering from the reflection mirror 7. The quarter wavelength plate 11 is a type of so-called wavelength plate, and is formed from a birefringent material, for example. Typically, the quarter wavelength plate 11 is for converting entering linearly polarized light into circularly polarized light that oscillates in a direction that is inclined by 45 degrees with respect to an oscillation direction of the linearly polarized light. The quarter wavelength plate 11 of the present embodiment takes an oscillation direction of display light that is emitted by the display 3A as a reference oscillation direction, and converts the display light entering from the polarizing member 5A into display light (circularly polarized light) that oscillates in a direction inclined by 45 degrees with respect to the reference oscillation direction, and transmits the display light. That is, the quarter wavelength plate 11 converts linearly polarized light that is reflected by the polarizing member 5A into left-handed circularly polarized light that is inclined by 45 degrees. Furthermore, the quarter wavelength plate 11 converts display light that is reflected by the reflection mirror 7 and transmitted toward the polarizing member 5A, into display light (circularly polarized light) that oscillates in a direction orthogonal to the reference oscillation direction. That is, the quarter wavelength plate 11 converts the circularly polarized light reflected by the reflection mirror 7 into linearly polarized light that is orthogonal to the reference oscillation direction. In this manner, the quarter wavelength plate 11 converts linearly polarized light that is transmitted, into circularly polarized light, and converts circularly polarized light that is transmitted, into linearly polarized light. The circularly polarized light that is transmitted through the quarter wavelength plate 11 from the reflection mirror 7 to the polarizing member 5A side is circularly polarized light of opposite handedness from the circularly polarized light that is transmitted through the quarter wavelength plate 11 from the polarizing member 5A to the reflection mirror 7 side.

Next, a display operation of the vehicle display device 1C will be described with reference to FIG. 4. First, display light that is emitted by the display 3A is propagated toward the polarizing member 5A. The polarizing member 5A reflects the display light entering from the display 3A, toward the quarter wavelength plate 11. The quarter wavelength plate 11 transmits the display light entering from the polarizing member 5A, toward the reflection mirror 7. The display light entering from the reflection mirror 7 is totally reflected by a concave reflection surface, and is propagated again toward the quarter wavelength plate 11. The quarter wavelength plate 11 transmits the display light entering from the reflection mirror 7, toward the polarizing member 5A. The polarizing member 5A transmits the display light entering from the quarter wavelength plate 11, toward the screen S. A display image is thereby projected on the screen S, and the display image is displayed before an eye point 201 of a driver 200.

The vehicle display device 1C described above includes the polarizing member 5A that forms a part of the instrument panel 102, and that reflects the first linearly polarized light from the display 3A, where the polarizing member 5A reflects display light that is emitted by the display 3A, toward the quarter wavelength plate 11, and transmits display light that is reflected by the reflection mirror 7, toward the screen S. By causing display light to be reflected by the polarizing member 5A in this manner, a same effect as the effect that is obtained by the vehicle display device 1B described above may be obtained.

Additionally, in the second and third embodiments, the polarizing member 5A is formed by combining a light-transmitting member and a polarizing film, but such a case is not restrictive, and a light-transmitting member and a polarizing plate may be integrally formed instead.

In the second and third embodiments, the reflection mirror 7 includes a function of a magnifying mirror, but such a case is not restrictive, and a function of the correction mirror described above may also be included. The reflection mirror 7, 9 that functions as a magnifying mirror and a correction mirror is formed as a freely curved surface mirror which is asymmetric with respect to an optical axis, unlike a spherical surface or a paraboloidal surface. Accordingly, display distortion of a display image that is formed by display light may be corrected by the display light being reflected by the reflection mirror 7, and display quality may be improved.

### Fourth Embodiment

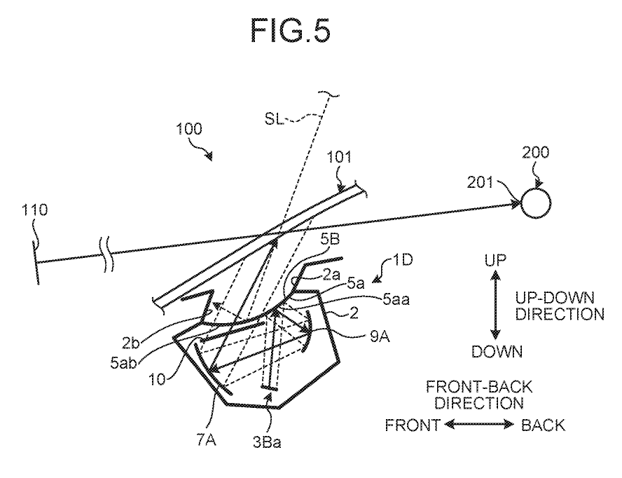

A projection device 1D according to a fourth embodiment of the present invention will be described with reference to FIG. 5. FIG. 5 is a schematic configuration diagram of the projection device according to the fourth embodiment. The projection device 1D according to the present embodiment is different from the projection device 1A described above in that a half-wavelength plate 10 is disposed at a position facing a transparent cover 5B, and display light entering from a reflection mirror 7A is transmitted toward the transparent cover 5B. The projection device 1D includes a housing 2, a display 3Ba, the transparent cover 5B, the half-wavelength plate 10, and reflection mirrors 7A, 9A.

The half-wavelength plate 10 is disposed on an optical path of display light, at a position facing the transparent cover 5B, and the half-wavelength plate 10 transmits display light entering from the reflection mirror 7A toward the transparent cover 5B. The half-wavelength plate 10 of the present embodiment takes an oscillation direction of display light that is emitted by the display 3Ba as a reference oscillation direction, and converts display light entering from the reflection mirror 7A into display light that oscillates in a direction inclined by 90 degrees with respect to the reference oscillation direction, and transmits the display light. The half-wavelength plate 10 converts linearly polarized light that is reflected by a convex curved surface 5a of the transparent cover 5B into linearly polarized light that oscillates in a direction orthogonal to the reference oscillation direction.

The reflection mirrors 7A, 9A of the present embodiment are for reflecting, in the housing 2, display light that is reflected by the transparent cover 5B, toward the half-wavelength plate 10. The reflection mirror 9A of the present embodiment totally reflects display light that is reflected by the transparent cover 5B, toward the reflection mirror 7A. The reflection mirror 7A of the present embodiment totally reflects the display light that is reflected by the reflection mirror 9A, toward a windshield 101 through the half-wavelength plate 10 and the transparent cover 5B.

Next, a projection operation of the projection device 1D will be described with reference to FIG. 5. First, display light that is emitted by the display 3Ba is propagated toward the transparent cover 5B. The transparent cover 5B reflects the display light entering from the display 3Ba, toward the reflection mirror 9A by the convex curved surface 5a (reflection surface 5aa thereof). The reflection mirror 9A reflects the display light entering from the transparent cover 5B, toward the reflection mirror 7A. The display light entering the reflection mirror 7A is totally reflected by concave reflection surface, and is propagated toward the half-wavelength plate 10. The half-wavelength plate 10 transmits the display light entering from the reflection mirror 7A, toward the transparent cover 5B. The transparent cover 5B transmits the display light entering from the half-wavelength plate 10, toward the windshield 101 from the convex curved surface 5a (transmission surface 5ab thereof) and through a concave curved surface 5b. A display image is thereby projected on the windshield 101, and a virtual image 110 is displayed before an eye point 201 of a driver 200.

With the projection device 1D described above, the transparent cover 5B reflects first linearly polarized light that is emitted by the display 3Ba, and transmits, toward the windshield 101, second linearly polarized light that is obtained by conversion of the first linearly polarized light by the half-wavelength plate 10. By causing the transparent cover 5B to include a function of a polarizing plate, and by causing the transparent cover 5B to reflect and transmit display light, a same effect as the effect that is obtained by the projection device 1A described above may be obtained.

The above-described first to fourth embodiments describe cases where the present invention is applied to the vehicle 100, but such a case is not restrictive, and application to other than the vehicle 100, such as a ship or an aircraft, is also possible, for example.

With the projection device and the vehicle display device according to the present embodiments, an increase in the size of the display screen, and reduction in the size of the housing may be achieved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A projection device comprising:
a display that emits, as display light, a display image that is projected on a projected member provided in a vehicle;
a cover member that blocks an opening formed at a housing, and that reflects the display light that is emitted by the display;
an aspheric mirror that is located at a position of folding an optical path of the display light between the display and the projected member, and that reflects the display light entering from the cover member; and
a half-wavelength plate that is disposed on the optical path of the display light, at a position facing the cover member, and that transmits the display light entering from the cover member, toward the aspheric mirror, wherein
the display emits a first linearly polarized light that oscillates in a reference oscillation direction,
the half-wavelength plate converts the first linearly polarized light entering from the cover member into a second linearly polarized light that oscillates in a direction orthogonal to the reference oscillation direction, and transmits the second linearly polarized light, and
the cover member includes a convex curved surface protruding toward an interior of the housing, and is structured to reflect the first linearly polarized light that is emitted by the display, toward the half-wavelength plate, and to transmit the second linearly polarized light from the aspheric mirror toward the projected member.

2. A projection device comprising:
a display that emits, as display light, a display image that is projected on a projected member provided in a vehicle;
a cover member that blocks an opening formed at a housing, and that reflects the display light that is emitted by the display;
an aspheric mirror that is located at a position of folding an optical path of the display light between the display and the projected member, and that reflects the display light entering from the cover member; and
a half-wavelength plate that is disposed on the optical path of the display light, at a position facing the cover member, and that transmits the display light entering from the aspheric mirror, toward the cover member, wherein
the display emits a first linearly polarized light that oscillates in a reference oscillation direction,
the half-wavelength plate converts the first linearly polarized light entering from the aspheric mirror into a second linearly polarized light that oscillates in a direction orthogonal to the reference oscillation direction, and transmits the second linearly polarized light, and
the cover member includes a convex curved surface protruding toward an interior of the housing, and is structured to reflect the first linearly polarized light that is emitted by the display, toward the aspheric mirror, and to transmit the second linearly polarized light that is transmitted through the half-wavelength plate, toward the projected member.

3. A vehicle display device comprising:
a display that emits, as display light, a display image that is projected on a projected member;
a polarizing member that forms a part of an interior member that is provided in a vehicle interior of a vehicle, on a front side, in a front-back direction, of the vehicle, while extending in a width direction intersecting the front-back direction of the vehicle, the polarizing member being configured to reflect at least a part of the display light that is emitted by the display;
a reflection member that is located at a position of folding an optical path of the display light between the polarizing member and the projected member, and that reflects the display light; and
a wavelength plate that is located on the optical path of the display light, and that transmits the display light, wherein
the display emits a first linearly polarized light that oscillates in a reference oscillation direction,
the wavelength plate converts the first linearly polarized light into a second linearly polarized light that oscillates in a direction orthogonal to the reference oscillation direction, and
the polarizing member is structured to reflect the first linearly polarized light, and to transmit the second linearly polarized light toward the projected member.

4. The vehicle display device according to claim 3, wherein
the wavelength plate is disposed between the polarizing member and the reflection member, and converts the first linearly polarized light that is reflected by one of the polarizing member or the reflection member into the second linearly polarized light.

5. The vehicle display device according to claim 3, wherein
the projected member has a light-transmitting property, and is disposed facing the vehicle interior, at a position visible to a driver in the vehicle interior.

6. The vehicle display device according to claim 4, wherein
the projected member has a light-transmitting property, and is disposed facing the vehicle interior, at a position visible to a driver in the vehicle interior.
